(19) United States
(12) Patent Application Publication
(10) Pub. No.: US 2016/0170620 A1
(43) Pub. Date: Jun. 16, 2016

(54) SYSTEMS AND METHODS FOR PRESENTING SUMMARY INFORMATION ASSOCIATED WITH MAP ELEMENTS

(71) Applicant: ZAG HOLDINGS INC., Toronto (CA)

(72) Inventors: Igal Roytblat, Richmond Hill, Ontario (CA); Jonathan Haldane, Mississauga (CA)

(21) Appl. No.: 14/908,604

(22) PCT Filed: Jul. 15, 2014
(86) PCT No.: PCT/CA2014/050671

§ 371 Date: Jan. 29, 2016

Related U.S. Application Data
(60) Provisional application No. 61/861,785, filed on Aug. 2, 2013.
(60) Provisional application No. 61/889,204, filed on Oct. 10, 2013.

(51) Int. Cl. G06F 3/0484; G06T 11/60

(52) U.S. Cl. CPC G06F 3/04847; G06F 3/04842; G06T 11/60

(57) ABSTRACT

Systems and methods are provided for rendering, on a spatial region of a map, summary information associated with map elements such as points of interest, according to selected attributes that may be dynamically filtered by the user. In some embodiments, summary data associated with the map elements within one or more sub-regions residing within, or overlapping with, the spatial region, is obtained, where the summary data includes, for each sub-region, the number of map elements within the sub-region that are associated with different permutations of the selectable attributes. The summary data is then processed to obtain summary information including the number of map elements within each sub-region that correspond to the set of selected attributes.

### CROSS-REFERENCE TO RELATED APPLICATION

This application claims priority to U.S. Provisional Application No. 61/861,785, titled “SYSTEMS AND METHODS FOR PRESENTING SUMMARY INFORMATION ASSOCIATED WITH MAP ELEMENTS” and filed on Aug. 2, 2013, the entire contents of which is incorporated herein by reference, and to U.S. Provisional Application No. 61/889,204, titled “SYSTEMS AND METHODS FOR PRESENTING SUMMARY INFORMATION ASSOCIATED WITH MAP ELEMENTS” and filed on Oct. 10, 2013, the entire contents of which is incorporated herein by reference.

### BACKGROUND

The present disclosure relates to systems and methods for presenting visual information associated with spatial regions, such as maps.

Modern computer mapping software and applications typically employ a user interface that allows presentation of mapping data at different zoom levels based on a quad-tree representation of map elements. A database of spatial elements is employed and linked to the quad-tree representation, allowing relevant elements or collections of elements to be displayed at a zoom level associated with a set of quad tree nodes. Unfortunately, such solutions are often associated with latency and bandwidth limitations due to the need to repeatedly download large quantities of information for each zoom level in order to render relevant points of interest and to process user queries.

### SUMMARY

Systems and methods are provided for rendering, on a spatial region of a map, summary information associated with map elements such as points of interest, according to selected attributes that may be dynamically filtered by the user. In some embodiments, summary data associated with the map elements within one or more sub-regions residing within, or overlapping with, the spatial region, is obtained, where the summary data includes, for each sub-region, the number of map elements within the sub-region that are associated with different permutations of the selectable attributes. The summary data is then processed to obtain summary information including the number of map elements within each sub-region that correspond to the set of selected attributes.

Accordingly, in one aspect, there is provided a computer implemented method of displaying, on a client computing device, summary information associated with map elements residing at locations within a map, wherein each map element has one or more attributes associated therewith, the method comprising:

displaying a spatial region of the map;

rendering a user interface comprising a filter for selecting attributes of the map elements;

obtaining, from a remote server, summary data associated with the map elements within one or more sub-regions residing within, or overlapping with, the spatial region, wherein the summary data comprises, for each sub-region, the number of map elements within the sub-region that are associated with different permutations of the selectable attributes;

receiving input from a user specifying a set of selected attributes;

processing, on the client computing device, the summary data to obtain summary information comprising the number of map elements within each sub-region that correspond to the set of selected attributes; and

displaying the summary information associated with each sub-region.

In another aspect, there is provided a computer-implemented method of providing, to a remote client computing device, summary data associated with attributes of map elements residing within a spatial region of a map, the method comprising:

accessing a map element database comprising, for each map element, a location and a set of attributes associated with the map element;

processing the location and set of attributes associated with the map elements within the map element database to determine, for a plurality of hierarchical regions within the map, the number of map elements within each hierarchical region that are associated with different permutations of the attributes, and storing this information in a data structure;

receiving, from a client computing device, a request to provide summary data for a selected spatial region of the map;

processing the data structure to determine, for a plurality of sub-regions within the selected region, summary data comprising the number of map elements within each sub-region that are associated with different permutations of the attributes; and

transmitting the summary data to the remote client computing device.

In another aspect, there is provided a computer-implemented method of providing, to a remote client computing device, summary data associated with attributes of map elements residing with a spatial region of a map, the method comprising:

receiving, from a client computing device, a request to provide summary data for a selected spatial region of a map;

accessing a map element database comprising, for each map element, a location and a set of attributes associated with the map element;

obtaining the location and set of attributes associated each map element within the selected spatial region;

processing the location and set of attributes associated with map elements within the selected spatial region to determine, for a plurality of sub-regions within the selected region, summary data comprising the number of map elements within each sub-region that are associated with different permutations of the attributes; and

transmitting the summary data to the remote client computing device.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1 provides a block diagram of an example system configured for rendering, on a client computing device, summary information within a spatial region of a map according to filtered attributes of points of interest.

FIG. 2 is a flow chart illustrating an example method of rendering summary information within a spatial region of a map according to filtered attributes of points of interest.

FIGS. 3(a) and 3(b) show examples of summary data, showing the number of points of interest corresponding to the different permutations of attributes, based on (a) non-exclusive and (b) exclusive permutations.

FIGS. 4(a) and 4(b) show alternative examples of summary data, in which each permutation has associated therewith an average location, based on (a) non-exclusive and (b) exclusive permutations.

FIG. 5 schematically illustrates the spatial organization and interrelationship of tiles in a quad tree structure, showing the three levels of the quad tree with their associated child nodes.

FIG. 6 illustrates an example map with a quad tree overlaid thereon, including three levels of quad tree tiles, and a user-selected spatial region.

FIG. 7 shows the rendering of summary information associated with hotels based on user-selected filter options, for the user-selected spatial region shown in FIG. 6.

FIG. 8 shows the rendering of summary information associated with hotels based on alternative user-selected filter options, for the user-selected spatial region shown in FIG. 6.

FIG. 9 is a block diagram illustrating an example implementation of a computing device.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. Unless otherwise specified, the terms “about” and “approximately” mean plus or minus 10 percent or less.

It is to be understood that unless otherwise specified, any specified range or group is as a shorthand way of referring to each and every member of a range or group individually, as well as each and every possible sub-range or sub -group encompassed therein and similarly with respect to any sub-ranges or sub-groups therein. Unless otherwise specified, the present disclosure relates to and explicitly incorporates each and every specific member and combination of sub-ranges or sub-groups.

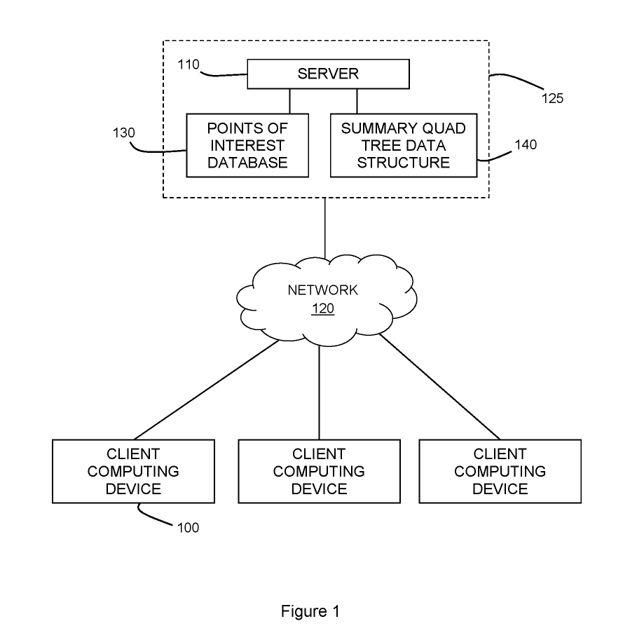

Referring now to FIG. 1, a block diagram is provided illustrating an example system for rendering, on a client computing device, summary information associated with points of interest, according to one example embodiment of the present disclosure. One or more client computing devices 100 are connected to a remote computing environment 125 for obtaining mapping information associated with points of interest.

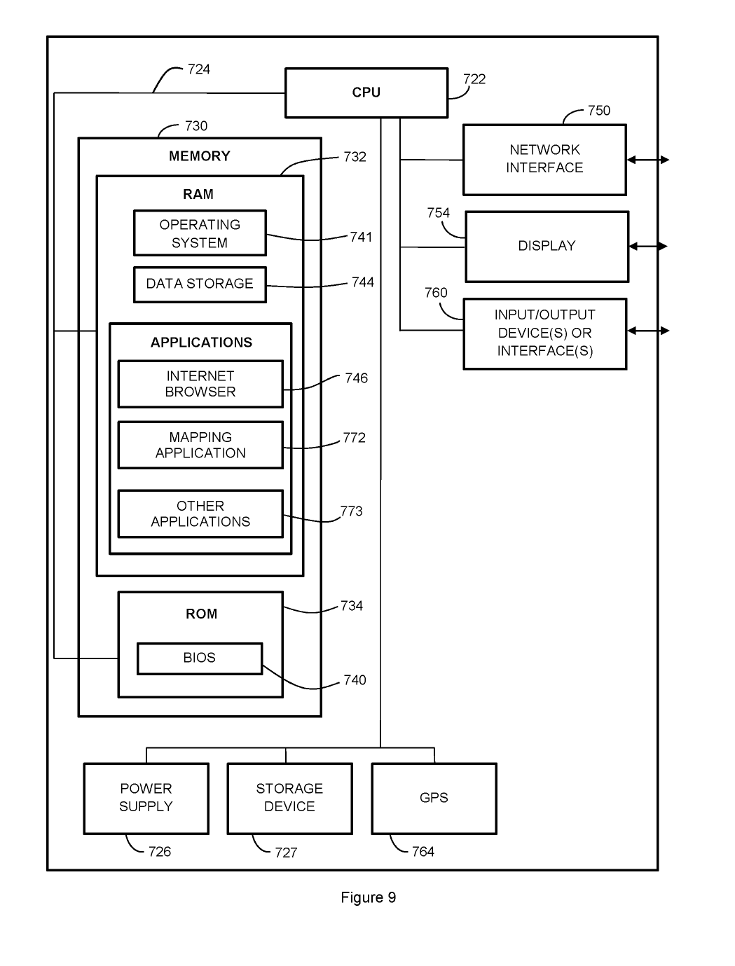

Client computing device 100 enables a user to view and a select spatial region within a map, and to control the display of information associated with points of interest. Client computing device 100 may be, for example, a mobile computing device such as a tablet, smartphone, laptop, navigation system, and automotive display, or another computing device such as a personal computer, computer kiosk, or other fixed computing device. A more detailed example of an example computing device 100 is provided in FIG. 9, and described in further detail below.

As noted above, client computing device is configured such that a user can view and select (or control) the displayed spatial region of a map. For example, client computing device 100 may be programmed with a mapping application such as a web app, or an executable mapping program. Client computing device 100 also provides a user interface that enables the user to control the display of information associated with points of interest by filtering the attributes of the points of interest.

Client computing device 100 communicates with server 110 through network 120 to obtain information associated with points of interest. Information associated with individual points of interest is stored in POI database 130, which is accessible to server 110. Summary information associated with the points of interest, contained within summary quad tree data structure 140 (described in detail below), is also accessible to server 110. One or more of POI database 130 and summary quad tree data structure 140 may reside on a common computing device with server 110, or may reside external to server 110 (for example, connected to server 110 over an internal or external network). Spatial information associated with the displayed map may also be obtained from server 110.

As noted above, POI database 130 contains information associated with individual points of interest. In one embodiment, a point of interest is an element in the map having a type, location, and one or more categorizable attributes. Non-limiting examples of types of points of interest are hotels and restaurants.

The attributes of a point of interest further characterize and categorize the point of interest beyond its type. It is noted that the attributes may be different among different types of points of interest. For example, the attributes of “star rating” and “amenities”, which while being suitable for characterizing and categorizing hotels, would not be appropriate attributes for restaurants. Accordingly, attributes may be type-specific, such as the presence of a pool at a hotel, or an outdoor patio at a restaurant. A given attribute may be single-valued or multi-valued. An example of a single-valued (exclusive) attribute is the star rating of a hotel. The star rating is a single-valued attribute because a hotel can only have one star rating. An example of a multi-valued attribute is hotel amenities, which can take on one or more values, such as the presence of a pool, fitness center, or business center.

Examples of point of interest types and attributes are as follows:
Type: Hotel, restaurant, hospital, place of worship
Name: Hotel or restaurant name
Location: Street address, and/or latitude and longitude
Attributes (Hotel example):
   Star rating
   Amenities (e.g. business center, fitness center, pool)
   Chain (e.g. Hyatt, Hilton, Marriott)
   Affiliate

As noted above, POI database 130 contains data elements specifying the type, name, location and attributes of each point of interest. An example data element of POI database is as follows:
Type: Hotel
Name: Fairmont Royal York
Location: 43.64594 N, -79.38253 W
Attributes:
   Star rating: 4 star
   Amenities: Business center, fitness center, pool
   Chain: Fairmont

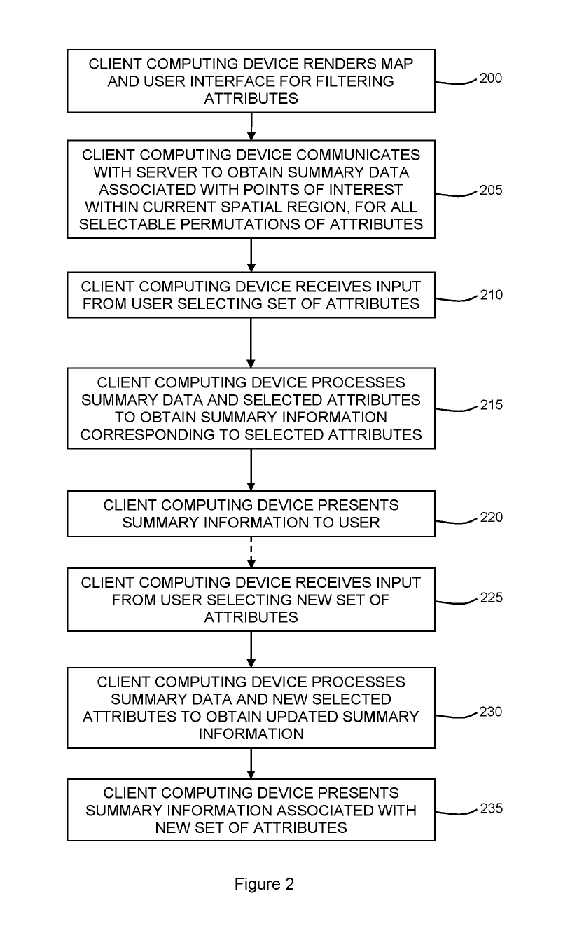

Referring now to FIG. 2, example methods of rendering summary information associated with points of interest residing within a spatial area of a map are described. FIG. 2 provides a flow chart illustrating one example method of rendering summary information within a spatial region of a map according to filtered attributes of points of interest.

In step 200, the client computing device renders, on a user interface associated with a mapping application, a map with a selectable spatial region, and selectable options for filtering point of interest information according to attributes, such that a specifics attributes for a given point of interest type can be selected by the user.

The initial spatial region rendered on the client computing device may be automatically determined without receiving input from the user. For example, the initial center location and zoom level may be determined based on location information associated with the client device (for example, centering the spatial region at the location corresponding to the client device, and employing a default zoom level to render the map). In another alternative example implementation, the initial zoom level may be the entire world (e.g. a rendering of a rotating or rotatable globe), without requiring an initial focus or center location.

In step 205, the client computing device communicates with the server to obtain summary data associated with the points of interest residing within the current spatial region (e.g. the initially displayed spatial region, or a spatial region selected by the user). The summary data includes the number of points of interest for each permutation of attributes.

In one example implementation, the summary data may be provided such that the number of points of interest for each permutation is provided in a non-exclusive manner. According to such a non-exclusive embodiment, the number of points of interest corresponding to a given permutation of attributes includes all points of interest having at least the selected attributes. For example, if the point of interest type is a hotel, and the attributes are amenities (pool, fitness center, and business center), then one permutation of attributes may correspond to hotels that have at least a pool and a fitness center (and may or may not also have a business center), while another permutation of attributes may correspond to hotels that have at least a pool (and may or may not also include a fitness center and a business center).

In one example implementation, the summary data may be provided such that the number of points of interest for each permutation is provided in an exclusive manner. According to such an exclusive embodiment, the number of points of interest corresponding to a given permutation of attributes includes all points of interest having only the selected attributes. For example, if the point of interest type is a hotel, and the attributes are amenities (pool, fitness center, and business center), then one permutation of attributes may correspond to hotels that have a pool and a fitness center (and do not have a business center), while another permutation of attributes may correspond to hotels that have a pool (and do not have a fitness center or a business center).

In some embodiments, the summary data may include only those permutations having non-null values. For example, in an exclusive embodiment, if the point of interest type is a hotel, and there are no 5-star hotels without a pool, then no information concerning this exclusive permutation need be provided. This reduces the amount of information that is provided to the client device, increasing the speed of rendering the summary information for a given query.

It will be understood that the summary data may be provided in any form or representation that is suitable for describing the attribute permutations associated with the current spatial area of the map. For example, the summary data may be provided as a table, where each entry of the table relates to a unique (and optionally non-null) permutation.

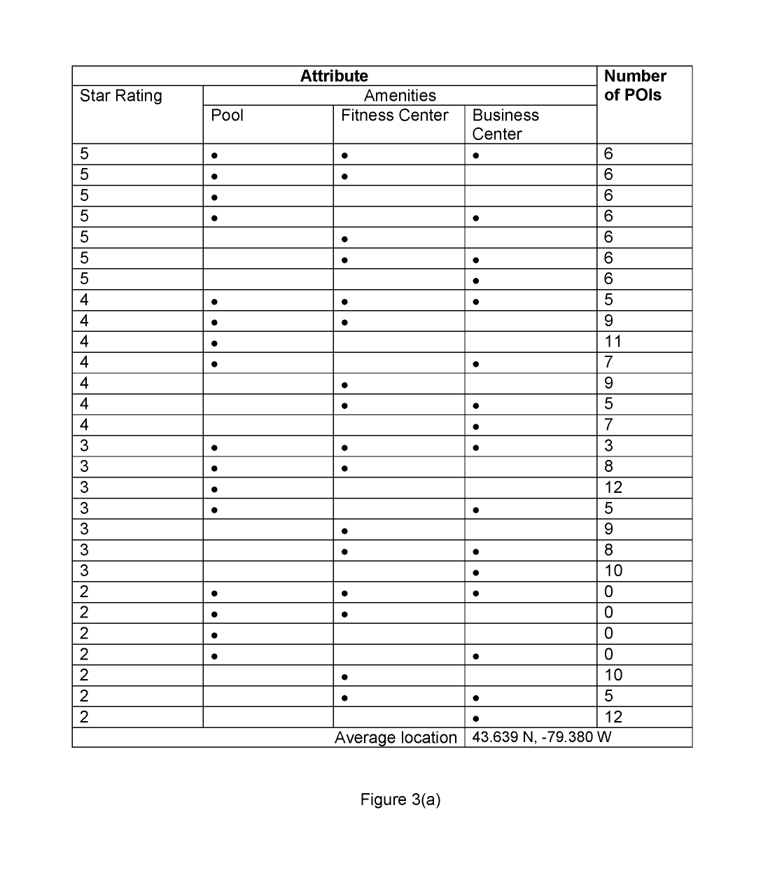

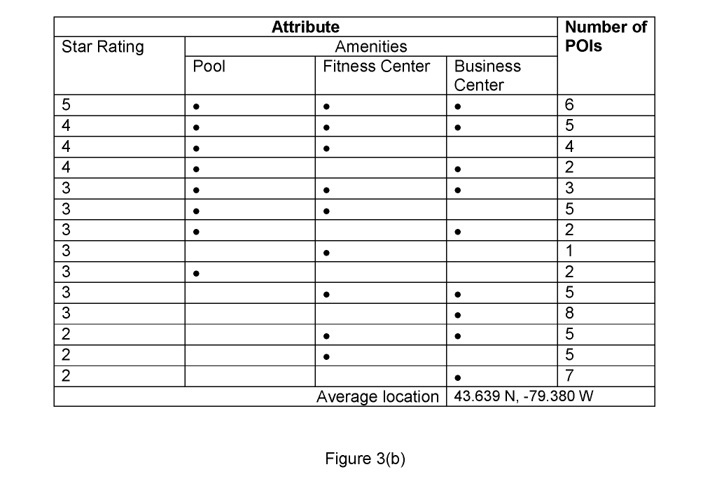

FIG. 3(a) provides a table illustrating an example format of summary data that may be provided to the client device, for the example case when the point of interest is a hotel, and the selectable attributes are star rating and amenities including a pool, fitness center, and a business center. The summary data is provided in a non-exclusive format, such that points of interest for a given permutation are based on the inclusion of the selected attributes, without excluding points of interest having unselected attributes. Note that in the present example, all 6 or the five star hotels have pool, a fitness center, and a business center, with the result that the number of five star hotels for each non-exclusive permutation is 6. The summary data also optionally includes an average location of all of the points of interest.

FIG. 3(b) illustrates an alternative embodiment in which the summary data is provided in an exclusive format. The summary data shows the number of points of interest corresponding to each non-null permutation. This results in a smaller table due to the condensing of the permutations. For example, since there is only one unique permutation of five star hotels (i.e. the one having all amenities), only one non-null permutation is provided in the table for five star hotels. In order to determine the number of points of interest corresponding to a given set of attributes, without excluding points of interest not having the non-selected attributes, the results from multiple exclusive permutations may need to be summed. For example, in order to determine the number of four star hotels having at least a pool, the number of hotels is obtained by summing all three exclusive permutations (5+4+2), resulting in a total of 11 hotels. This is to be contrasted with FIG. 3(a), in which the number of hotels with at least a pool can be obtained directly from the non-exclusive permutation involving only a pool.

It will be understood that both the exclusive and non-exclusive example embodiments described above also permit the determination of the number of points of interest corresponding to a selection of some attributes with the exclusion of other attributes. Such information is more readily accessible from summary data formatted according to an exclusive embodiment.

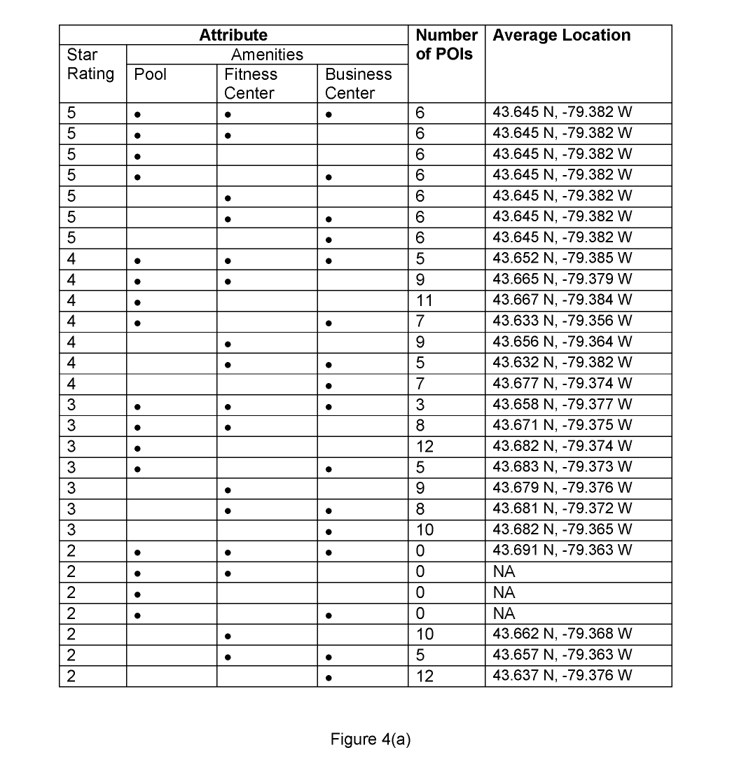

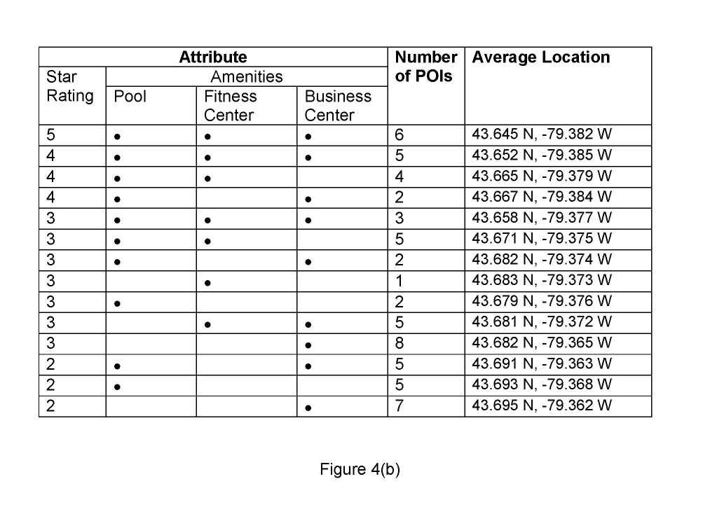

As shown in FIG. 4(a) (non-exclusive) and FIG. 4(b) (exclusive), the summary data may include average location data for each permutation. As described further below, this enables the presentation of a graphical marker corresponding to the summary information that pertains to the specific set of attributes that are selected.

Is noted that this summary data may be provided for one or more types of points of interest. For example, the user interface may contain a first set of filter options for selecting attributes for hotels, and a second set of filter options corresponding to restaurants.

Furthermore, the summary data may be obtained from the server according to a number of different implementations. In one example, the summary data may be obtained by processing, at the server, the information within the point of interest database to generate, in response to a query from the client computing device, the summary data associated with the spatial region displayed on the client computing device.

In another example implementation, the summary data may pre-computed, for a set of hierarchical spatial regions of the map, and stored data structure that is accessible to the server. An example implementation of such a data structure is based on a quad tree, as described in further detail below.

In step 210, the client computing device receives, from the user, a set of selected attributes. For example, in the example case in which the type of attribute is a hotel, the selected attributes may be a five star rating, and the presence of a pool.

In step 215, the client computing device processes the summary data to obtain summary information corresponding to the selected attributes. For example, referring to the summary data shown in the table of FIG. 3(a), if the selected attributes (i.e. the filtered attributes) correspond to three star hotels with a pool, the number of points of interest is obtained directly from the table, yielding 12 hotels. If, on the other hand, the summary data is provided as shown in FIG. 3(b), the number of hotels with a pool is obtained by summing the permutations satisfying this criteria (3+5+2+2), resulting in a total of 12 hotels. In another example, if the selected attributes correspond to four star hotels with a business center and a fitness center (and optionally a pool), this set of attributes would correspond to a total of 5 hotels.

In step 220, the summary information corresponding to the selected attributes is displayed, presented, or otherwise communicated to the user. For example, the user interface may display the total number of points of interest within the selected spatial region corresponding to the selected attributes.

In some embodiments, the summary information may be provided as aggregate information describing the spatial region displayed on the client computing device. For example, the summary information may be displayed to the user as the total number of points of interest satisfying the selected attributes, and an average location of the points of attributes.

In other embodiments, the summary information may be provided such that summary information is given for a plurality of sub-regions within the spatial region displayed on the client device. For example, the spatial region can be sub-divided into a number of sub-regions, and summary information, and average location information, may be provided for each sub-region. An example implementation of such an embodiment is provided below, according to an implementation based on a quad data structure.

In some cases, the user may wish to view summary information associated with a different set of attributes, without having changed the selected spatial area. For example, the user, having obtained summary information associated with the number of five-star hotels with a pool, may subsequently wish to obtain summary information regarding the number of four-star hotels with a pool. Such a scenario is described in step 225 of FIG. 2, in which the user selects a new set of attributes, i.e. the user changes the attributes that are used to filter the summary data.

Since the client computing device has already obtained, from the user, the summary data corresponding to all permutations of attributes within the current spatial region, the client computing device need not further communicate with the server prior to determining the updated summary information corresponding to the newly selected attributes. Accordingly, in step 235, client device processes the summary data and the newly selected attributes to obtain updated summary information corresponding to the newly selected attributes, without requiring communication with the server. The client computing device may then present the updated summary information to the user, without a delay associated with communication with the server, and processing by the server.

The user may therefore rapidly modify the selected attributes and rapidly view the updated summary information, without experiencing delays and latency associated with communication with the server, and also without susceptibility to network instability or unavailability.

In the event that the user selects a different spatial region, the method may be repeated, beginning with step 200.

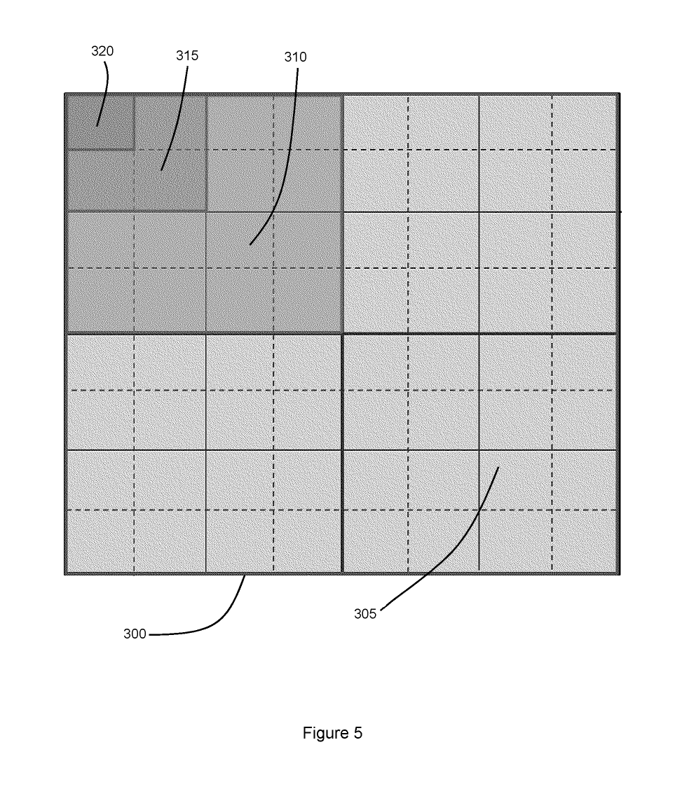

FIGS. 5-9 illustrate an example implementation of the method described in FIG. 2, in which the summary data is pre-computed as a quad tree data structure, and where the summary data provided to the client computing system is associated with quad tree nodes corresponding to the spatial area displayed on the client computing device.

Quad trees are data structures that are employed in mapping systems in order to provide a spatial index for efficient spatial queries. A quad tree can be represented as comprising a plurality of nodes arranged in a tree structure, where each node of the quad tree (that is not a leaf node) includes four child nodes (according to the example case of a 2D spatial representation). The tree is thus formed based on a recursive spatial relationship between a parent node and its child nodes, until the each path within the quad tree is terminated at a leaf node.

An example illustration of the spatial correspondence between one node of a quad tree, and its four child nodes, is provided in FIG. 5. As shown in the Figure, a portion of a quad tree 300 is represented by a parent quad tree node 305, which is subdivided into four first-generation child nodes, one of which is spatially represented by the darker grey tile 310. This first-generation child node itself includes four second-generation child nodes, one of which is spatially represented by the darker grey tile 315. Finally, this second-generation child node includes four third-generation child nodes, one of which is spatially represented by the darkest grey tile 320.

Although the present disclosure provides illustrations showing a quad tree formed from squares, it is to be understood that the quad tree can be based on other shapes. Furthermore, it is to be understood that the quad tree data structure need not be constrained to two spatial dimensions, and can, in other embodiments, be associated with a representation of a one-dimensional (uni-dimensional) map or dataset, or a representation of a three-dimensional volume or spatial region.

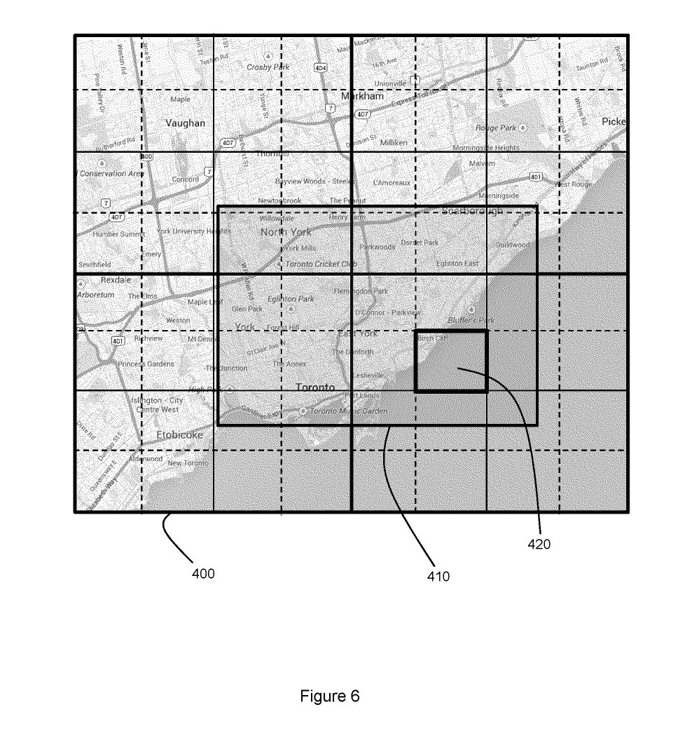

FIG. 6 illustrates an example map 400 having a quad tree spatial representation superimposed thereon. The quad tree is shown in a manner similar to that of FIG. 5, including a parent tile, first-generation tiles, second-generation tiles, and third-generation tiles. Tile 420, shown in bold, is an example of a third-generation tile.

As noted above, a portion of the map is rendered on the client computing device, according, for example, to a selected center position and a selected zoom level. An example spatial region to be displayed on the client computing device, and its association with quad tree tiles, is shown by grey rectangle 410.

In some embodiments, the quad tree spatial representation is employed as the summary data structure, which is accessible to the server, as shown, for example, in FIG. 1 at 140. The quad tree data structure may be computed, for a given type of point of interest, by computing, within each tile of the quad tree, the number of points of interest corresponding to each permutation of attributes (for example, each non-null permutation having a non-zero number of points of interest). For example, a given tile of the quad tree may include summary data such as that shown in FIGS. 3(a) and 3(b) or FIGS. 4(a) and 4(b). This quad tree data structure therefore includes the summary data in a sparse representation, compared to the detailed information residing in the POI database.

The quad tree note structure can be terminated at a leaf node according to a suitable criteria, such as when the total number of points of interest is less than a pre-selected threshold value. If the spatial area displayed on the client computing device includes one or more leaf nodes, then the actual points on interest within such nodes can be displayed, based on, for example, point of interest information obtained from the point of interest database accessible by the server.

Therefore, according to one example implementation, the summary data for a plurality of quad tree nodes/tiles of the map may be pre-computed and stored. The client computing device, displaying a selected spatial region of the map, will show a spatial region associated with a subset of the quad tree. For example, referring to FIG. 6, the selected spatial region 410 lies with a parent tile, overlaps with four first-generation tiles, nine second-generation tiles, and twenty five third-generation tiles (such as third-generation node 420).

The client computing device may then communicate with the server, requesting and obtaining summary data corresponding to tiles from a given generation (or level) the quad tree summary data structure. In the present non-limiting example, summary data is provided for all third-generation tiles, in order to provide a coarse, yet informative, spatial distribution of summary information.

Having obtained summary data associated with a given generation (or level) of tiles within the quad tree, the attributes selected from the filter may be employed to determine, based on processing of the summary data corresponding to each tile, the number of points of interest within the tile.

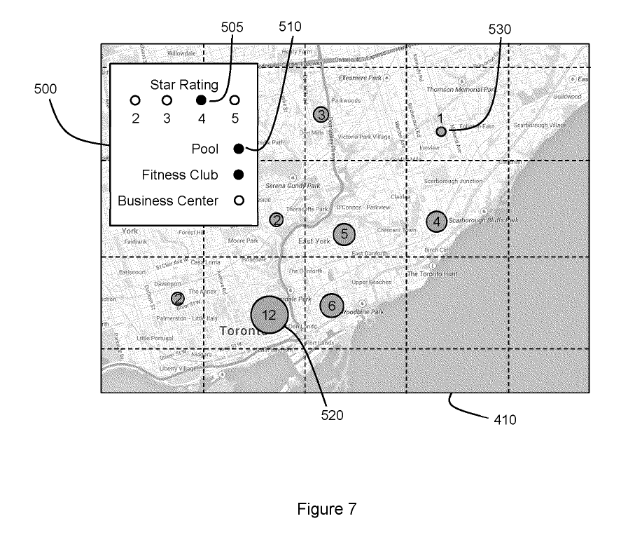

As shown in FIG. 7, which shows only the selected spatial region 410 of the map (displayed on the client device) and the third-generation quad tree tiles, the summary information, obtained on a per-tile basis, may be presented to the user on the rendered map. Included in FIG. 7 is an example attribute filter 500 via which the user can select attributes including the star rating and the amenities. The star rating in the present example has been selected as four stars (505), and the amenities have been selected as including a pool (510) and a fitness club. As shown in the Figure, the number of hotels meeting the selected attribute criteria in each third-generation tile is shown. For example, one tile the downtown portion of the city 520 includes 12 four star hotels with a pool and a fitness center, while a tile in the northeast portion of the city 530 includes only one such hotel.

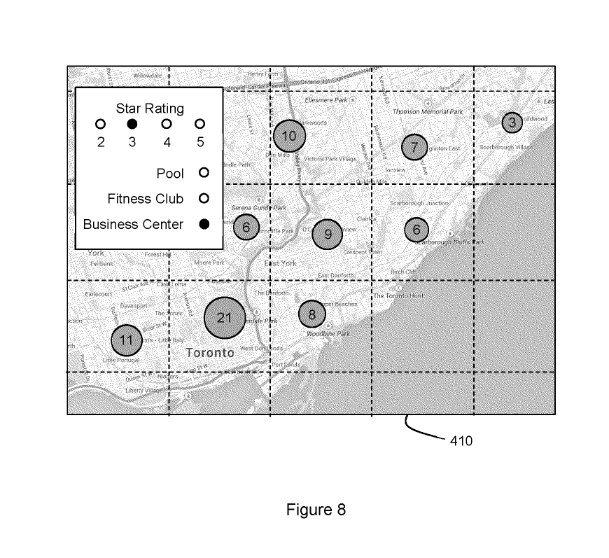

In the example implementation shown, the number of hotels is shown within the tile with an associated circle having a radius that scales according to the number of hotels (e.g. the radius increases with increasing number of hotels, for example, in a linear or logarithmic fashion). As described above, if the user selects a different set of attributes without changing the selected spatial region (using the attribute filter 500), the client computing device can calculate the updated summary information corresponding to the new set of attributes without having to request further information from the server. This may be achieved because the summary data initially obtained by the client computing device contains summary information pertaining to all permutations, and thus already includes the information needed to re-compute the summary information for a new set of selected attributes. Accordingly, if the selected attributes are changed as shown in FIG. 8, the summary info can be rapidly recomputed, as shown.

It is also noted that in the present example implementation, the center location of each circle is shown according to location information provided with the summary information. As noted above, the location information may be the average location of all points of interest within tile (of the relevant type). However, in the present example, the summary information includes location information associated with each permutation (as shown in FIGS. 4(a) and 4(b)), and therefore, the average point of interest location can be computed and displayed according to the selected attributes. This can be seen, for example, in FIG. 8, where the updated circles have changed location according to the newly selected attributes.

FIG. 9 illustrates an embodiment of an example computing device 100 that may be included in a system implementing the disclosure. Example computing device 100 may include many more or less components than those shown in FIG. 9. However, the components shown are sufficient to disclose an illustrative embodiment for practicing the present disclosure.

As shown in the figure, example computing device 100 includes a processing unit (CPU) 722 in communication with a mass memory 730 via a bus 724. Example computing device 100 also includes a power supply 726, one or more network interfaces 750, a display 754, input/output devices or interfaces 760, and an optional global positioning systems (GPS) receiver 764. Power supply 726 provides power to example computing device 100. A rechargeable or non-rechargeable battery may be used to provide power. The power may also be provided by an external power source, such as an AC adapter or a powered docking cradle that supplements and/or recharges a battery.

Example computing device 100 may optionally communicate with a base station (not shown), or directly with another computing device. Network interface 750 includes circuitry for coupling example computing device 100 to one or more networks, and is constructed for use with one or more communication protocols and technologies including, but not limited to, global system for mobile communication

(GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Network interface 250 is sometimes known as a transceiver, transceiving device, or network interface card (NIC). Example computing device may also or alternatively communicate with an external computing system via a wired connection, such as wired Ethernet.

Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Example computing device 100 may also include one or more input/output devices or interfaces 760, such as a keyboard or mouse, and/or one or more other for communicating with external devices, such as a headset, or other input or output devices not shown in FIG. 9. Input/output interface 760 can utilize one or more communication technologies, such as USB, infrared, Bluetooth™, Wi-Fi, Zigbee, or the like.

Optional GPS transceiver 764 can determine the physical coordinates of example computing device 100 on the surface of the Earth, which typically outputs a location as latitude and longitude values. GPS transceiver 764 can also employ other geo-positioning mechanisms, including, but not limited to, triangulation, assisted OPS (AGPS), E-OTD, CI, SAI, ETA, BSS or the like, to further determine the physical location of example computing device 100 on the surface of the Earth. It is understood that under different conditions, GPS transceiver 764 can determine a physical location within millimeters for example computing device 100; and in other cases, the determined physical location may be less precise, such as within a meter or significantly greater distances. In one embodiment, however, a computing device may through other components, provide other information that may be employed to determine a physical location of the device, including for example, a MAC address, IP address, or the like.

Mass memory 730 includes a RAM 232, a ROM 234, and other storage means. Mass memory 730 illustrates another example of computer storage media for storage of information such as computer readable instructions, data structures, program modules or other data. Mass memory 730 stores a basic input/output system (“BIOS”) 740 for controlling low-level operation of example computing device 100. The mass memory also stores an operating system 741 for controlling the operation of example computing device 100. It will be appreciated that this component may include a general purpose operating system such as a version of UNIX, or LINUX™, or a specialized client communication operating system such as iOS™, Android™, Windows Mobile™, or the Symbian® operating system. The operating system may include, or interface with a Java virtual machine module that enables control of hardware components and/or operating system operations via Java application programs.

Memory 730 further includes one or more data storage elements 744, which can be utilized by computing device 100 to store, among other things, applications 742 and/or other data. For example, data storage 744 may also be employed to store information that describes various capabilities of example computing device 100. The information may then be provided to another device based on any of a variety of events, including being sent as part of a header during a communication, sent upon request, or the like. Moreover, data storage 744 may also be employed to store personal information including but not limited to address lists, contact lists, personal preferences, or the like.

Applications 742 may include computer executable instructions which, when executed by example computing device 100, provide a web browser 746, a mapping application 772 for executing the method described herein. Applications 742 may also include other non-mapping applications 773. Other examples of application programs include calendars, email clients, IM applications, SMS applications, VOIP applications, contact managers, task managers, transcoders, database programs, word processing programs, security applications, spreadsheet programs, games, search programs, and so forth.

Browser 746 may be configured to receive and to send web pages, forms, web-based messages, and the like, and to render a mapping web app on example computing device 100. Browser 746 may, for example, receive and display (and/or play) graphics, text, multimedia, audio data, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

Embodiments of the disclosure can be implemented via the microprocessor(s) and/or the memory. For example, the functionalities described above can be partially implemented via hardware logic in the microprocessor(s) and partially using the instructions stored in the memory. Some embodiments are implemented using the microprocessor(s) without additional instructions stored in the memory. Some embodiments are implemented using the instructions stored in the memory for execution by one or more general purpose microprocessor(s). Thus, the disclosure is not limited to a specific configuration of hardware and/or software.

While some embodiments can be implemented in fully functioning computers and computer systems, various embodiments are capable of being distributed as a computing product in a variety of forms and are capable of being applied regardless of the particular type of machine or computer readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

A computer readable storage medium can be used to store software and data which when executed by a data processing system causes the system to perform various methods. The executable software and data may be stored in various places including for example ROM, volatile RAM, nonvolatile memory and/or cache. Portions of this software and/or data may be stored in any one of these storage devices. As used herein, the phrases “computer readable material” and “computer readable storage medium” refers to all computer-readable media, except for a transitory propagating signal per se.

Although the present disclosure has provided many illustrative embodiments related to points of interest on a map, it is to be understood that the scope of the disclosure is not intended to be limited to travel and tourism applications. In other embodiments, a point of interest may be any map element having a type, location, and one or more attributes. Accordingly, the POI database may be generalized as a map element database.

For example, a map element may be a type of accommodation that is viewable in a map rendered by a home resale application running on the client example computing device 100. Example types and attributes for such an example embodiment are as follows:
Types:
   Condominium
   Townhouse
   Detached home
Attributes: (detached home example):
   Number of bedrooms
   Number of washrooms
   Square footage (e.g. 0-1000, 1000-2000, 2000-3000, >3000)
   Number of garage spaces

It is also to be understood that the systems and method of the present disclosure may be adapted to a wide variety of other uses and applications, including, but not limited to, imaging, military (e.g. deployed resources such as vehicles, boats, aircraft), video games (e.g. civilization simulation games), geographical epidemiology studies, training and simulation, medical (education, display of results of diagnostic imaging, surgical training and simulation, and surgical navigation), mapping applications for home purchasing, inventory management, weather mapping. Furthermore, it will be understood that a map, in certain embodiments or implementations, need not be a geographical map, but can be another form of a map, such as an image of the body showing anatomical, physiological, or diagnostic elements (“points of interest”).

Although the preceding embodiments are illustrated through example implementations involving two-dimensional maps, it will be understood that the scope of the disclosure is not intended to be limited to two-dimensional maps (and two-dimensional quad tree data structures), and can be extended, for example, to three-dimensional maps or one-dimensional maps. Examples of three-dimensional implementations include a first-person shooter video game, a walkthrough simulation of homes and buildings, and three-dimensional medical imaging data involving image data voxels. An example of a one-dimensional implementation is a one-dimensional map of one or molecules, such as a genetic sequence of a nucleic acid, such as DNA or RNA, where the map elements (“points of interest”) could be specific sequences or bound probes.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A computer implemented method of displaying, on a client computing device, summary information associated with map elements residing at locations within a map, wherein each map element has one or more attributes associated therewith, the method comprising:
displaying a spatial region of the map;
rendering a user interface comprising a filter for selecting attributes of the map elements;
obtaining, from a remote server, summary data associated with the map elements within one or more sub-regions residing within, or overlapping with, the spatial region, wherein the summary data comprises, for each sub-region, the number of map elements within the sub-region that are associated with different permutations of the selectable attributes;
receiving input from a user specifying a set of selected attributes;
processing, on the client computing device, the summary data to obtain summary information comprising the number of map elements within each sub-region that correspond to the set of selected attributes; and
displaying the summary information associated with each sub-region.

2. The computer implemented method according to claim 1 wherein the summary data further comprises, for each sub-region, an average location associated with the map elements within the sub-region; and
wherein the average location for each sub-region is included in the summary information.

3. The computer implemented method according to claim 1 wherein the summary data further comprises, for each sub-region, location information comprising average location data associated with each permutation of the selectable attributes within each sub-region; and
wherein processing the summary data to obtain summary information further comprises, for each sub-region, determining an average location by processing the average location data for permutations associated with the set of selected attributes.

4. The computer implemented method according to claim 1 further comprising:
receiving input from the user specifying a set of modified attributes for the same spatial region;
processing the summary data to determine updated summary information without requiring communication with the remote server; and
displaying the updated summary information.

5. The computer implemented method according to claim 1 further comprising repeating the process of obtaining the summary data, processing the summary data, and displaying the summary information when the spatial region is modified by the user.

6. The computer implemented method according to claim 1 further comprising displaying information corresponding to specific map elements within a given sub-region if the number of map elements within the given sub-region is less than a pre-selected threshold.

7. The computer implemented method according to claim 1 wherein the permutations are non-exclusive permutations.

8. The computer implemented method according to claim 1 wherein the permutations are exclusive permutations.

9. The computer implemented method according to claim 1 wherein the summary data does not include permutations having null values.

10. The computer implemented method according to claim 1 wherein the summary data is obtained from a quad tree data structure stored on the remote server.

11. The computer implemented method according to claim 1 wherein an initial spatial region displayed is a map of the entire world.

12. The computer implemented method according to claim 1 wherein the spatial region is a user-selected spatial region that is a subset of an entire world map.

13. The computer implemented method according to claim 1 wherein the map is a two-dimensional map.

14. The computer implemented method according to claim 13 wherein the map is a geographical map.

15. The computer implemented method according to claim 14 wherein the map elements comprise points of interest.

16. The computer implemented method according to claim 1 wherein the map is a representation of a three-dimensional volume.

17. The computer implemented method according to claim 1 wherein the map pertains to an anatomical or physiological structure.

18. The computer implemented method according to claim 1 wherein the map is associated with a recorded image.

19. The computer implemented method according to claim 1 wherein the map is a representation of a one-dimensional dataset.

20. The computer implemented method according to claim 19 wherein the map is a map of one or more molecules.

21. A computer-implemented method of providing, to a remote client computing device, summary data associated with attributes of map elements residing within a spatial region of a map, the method comprising:
accessing a map element database comprising, for each map element, a location and a set of attributes associated with the map element;
processing the location and set of attributes associated with the map elements within the map element database to determine, for a plurality of hierarchical regions within the map, information comprising the number of map elements within each hierarchical region that are associated with different permutations of the attributes, and storing the information in a data structure;
receiving, from a client computing device, a request to provide summary data for a selected spatial region of the map;
processing the data structure to determine, for a plurality of sub-regions within the selected spatial region, summary data comprising the number of map elements within each sub-region that are associated with different permutations of the attributes; and
transmitting the summary data to the remote client computing device.

22. The computer-implemented method according to claim 21 wherein processing the data structure further comprises determining, for the plurality of sub-regions within the selected spatial region, summary data comprising an average location associated with each permutation of the attributes.

23. The computer-implemented method according to claim 21 wherein the data structure is a quad tree data structure.

24. A computer-implemented method of providing, to a remote client computing device, summary data associated with attributes of map elements residing with a spatial region of a map, the method comprising:
receiving, from a client computing device, a request to provide summary data for a selected spatial region of a map;
accessing a map element database comprising, for each map element, a location and a set of attributes associated with the map element;
obtaining the location and set of attributes associated each map element within the selected spatial region;
processing the location and set of attributes associated with map elements within the selected spatial region to determine, for a plurality of sub-regions within the selected spatial region, summary data comprising the number of map elements within each sub-region that are associated with different permutations of the attributes; and
transmitting the summary data to the remote client computing device.

25. The computer-implemented method according to claim 24 wherein processing the location and set of attributes associated with map elements within the selected spatial region further comprises determining summary data comprising an average location associated with each permutation of the attributes for each sub-region.
